(19) United States
(12) Patent Application Publication
(10) Pub. No.: US 2019/0012056 A1
(43) Pub. Date: Jan. 10, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Yusuke KAMOI, Kanagawa (JP)

(73) Assignee: FUJI XEROX CO., LTD., Tokyo (JP)

(21) Appl. No.: 16/013,294

(22) Filed: Jun. 20, 2018

(30) Foreign Application Priority Data
Jul. 4, 2017 (JP) 2017-131529

(51) Int. Cl. G06F 3/0485; G06F 3/0482; G06F 3/16; H04N 1/00

(52) U.S. Cl. CPC G06F 3/0485; G06F 3/0482; H04N 1/00472; H04N 1/00424; G06F 3/167

(57) ABSTRACT

An information processing apparatus includes: a display that displays plural operators for selection of service processes; and a detection unit that detects an operation state of a user before selection of any of the operators, wherein in a case where a predetermined operation state is detected, the display displays, on each of at least one or more of the plural operators displayed on the display, relevant information associated with the operator.

### CROSS-REFERENCE TO RELATED. APPLICATIONS

This application is based on and claims priority under 35 USC 119 from Japanese Patent Application No. 2017-131529 filed Jul. 4, 2017.

### BACKGROUND

### Technical Field

The present invention relates to an information processing apparatus and a non-transitory computer readable medium.

### SUMMARY

According to an aspect of the invention, there is provided an information processing apparatus that includes: a display that displays plural operators for selection of service processes; and a detection unit that detects an operation state of a user before selection of any of the operators, wherein in a case where a predetermined operation state is detected, the display displays, on each of at least one or more of the plural operators displayed on the display, relevant information associated with the operator.

### BRIEF DESCRIPTION OF THE DRAWINGS

Exemplary embodiments of the present invention will be described in detail based on the following figures, wherein:

FIG. 1 is a block diagram illustrating a hardware configuration of an image forming apparatus according to an exemplary embodiment of the present invention;

FIG. 2 is a schematic view illustrating an example of a home screen;

FIG. 3 is a schematic view illustrating an example of a home screen;

FIG. 4 is a schematic view illustrating an example of a home screen;

FIGS. 5A through 5C are schematic views each illustrating a display screen displayed in a case where a user creates a one-touch selection button;

FIG. 6 illustrates a list of one-touch selection buttons;

FIG. 7 is a flowchart illustrating an example of a flow of a “screen display process”;

FIG. 8 is a flowchart illustrating an example of of a “detection process”;

FIG. 9 is a flowchart illustrating an example of a flow of a “display changing process”;

FIG. 10 is a table showing a relationship among a service process, an operator, and relevant information;

FIG. 11 is a schematic view illustrating an example of a changed home screen;

FIG. 12 is a flowchart illustrating an example of a flow of a “detection process” according to a second exemplary embodiment;

FIG. 13 is a flowchart illustrating an example of a flow of a “display changing process” according to the second exemplary embodiment;

FIG. 14 is a schematic view illustrating an example of a changed home screen;

FIG. 15 is a flowchart illustrating an example of a flow of a “detection process” according to a reference example;

FIG. 16 is a flowchart illustrating an example of a flow of a “display changing process” according to the reference example; and

FIG. 17 is a schematic view illustrating an example of a changed home screen.

### DETAILED DESCRIPTION

Exemplary embodiments of the present invention are described in detail below with reference to the drawings.

### First Exemplary Embodiment

### Image Forming Apparatus

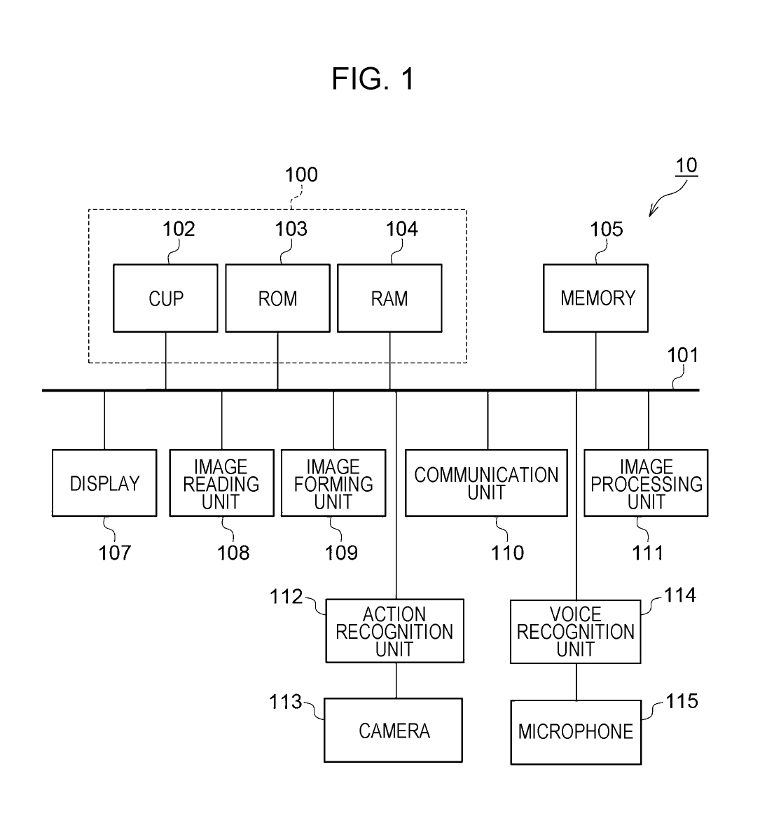

FIG. 1 is a block diagram illustrating a hardware configuration of an image forming apparatus 10 according to an exemplary embodiment of the present invention. The image forming apparatus 10 according to the present exemplary embodiment includes a controller 100, a memory 105, a display 107, an image reading unit 108, an image forming unit 109, a communication unit 110, an image processing unit 111, an action recognition unit 112, and a voice recognition unit 114. These functional units are connected to a bus 101 and exchanges data through the bus 101.

The controller 100 controls the functional units included in the image forming apparatus 10. The controller 100 is constituted by a central processing unit (CPU) 102, a read only memory (ROM) 103, and a random access memory (RAM) 104. In the present exemplary embodiment, a control program executed by the CPU 102 is stored in the ROM 103.

The CPU 102 reads out the control program stored in the ROM 103 and executes the control program while using the RAM 104 as a working area. As a result of execution of the control program by the CPU 102, the functional units of the image forming apparatus 10 are controlled. As a result, for example, predetermined display processing is performed on the display 107, and an image is formed on a recording medium. Furthermore, for example, a document placed on the image reading unit 108 is read.

The program executed by the CPU 102 can be offered while being recorded on a computer-readable recording medium such as a magnetic recording medium (e.g., a magnetic tape, a magnetic disc), an optical recording medium (e.g., an optical disc), an magnetooptical medium, or a semiconductor memory. Alternatively, the program executed by the CPU 102 may be downloaded into the image forming apparatus 10 by using communication means such as the Internet.

The display 107 is, for example, a liquid crystal touch panel display and, for example, displays data concerning the image forming apparatus 10 under control of the controller 100. Furthermore, the display 107 displays a display screen for receiving a user's operation. A user's operation such as selection of a button or page turning (scrolling) is received on the display screen. The received operation or screen transition is stored as an operation history in a memory such as the memory 105.

The image reading unit 108 includes an image reading device (scanner device) that reads a document and generates image data representing an image of the read document. The image reading unit 108 supplies image data generated by the scanner device to the image processing unit 111. The image forming unit 109 includes an image forming mechanism that forms a toner image based on the image data on a recording medium (e.g., a sheet of paper), for example, according to an electrophotographic system.

The communication unit 110 functions as a communication interface that is connected to a communication line (not illustrated) and communicates with another device connected to the communication line. The image processing unit 111 performs image processing such as color correction or gradation correction on input image data. The image processing unit 111 generates the image data that has been subjected to the image processing and then supplies the image data to the image forming unit 109. The memory 105 includes a storage device such as a hard disk device and stores therein, for example, data received by the communication unit 110 and data generated by the image forming apparatus 10.

The action recognition unit 112 is connected to a camera 113 that photographs the image forming apparatus 10. The camera 113 photographs, for example, a front side of the image forming apparatus 10. The action recognition unit 112 detects a user's predetermined action (gesture) on the basis of an image taken by the camera 113. Images of actions corresponding to operation instructions are stored in advance in the memory 105. The action recognition unit 112 acquires contents of an operation instruction given by an action by searching for a similar image from among the images of actions that are stored in advance by using an image recognition method such as pattern matching.

In the present embodiment, the action recognition unit 112 detects a “predetermined operation state” from a user's action (gesture) on the basis of an image taken by the camera 113. An image representing a “predetermined operation state” such as a “hesitating action” that will be described later is stored in advance in the memory 105. It is assumed that the action recognition unit 112 detects a “predetermined operation state” in a case where an image similar to the image representing the “predetermined operation state” is found from images taken by the camera 113.

The voice recognition unit 114 is connected to a microphone 115 that detects voice. The voice recognition unit 114 converts voice detected by the microphone 115 into digital voice data and converts digital voice data into text data. Character strings corresponding to operation instructions are stored in advance in the memory 105. The voice recognition unit 114 acquires contents of an operation instruction given by voice by searching for a character string stored in advance from the text data thus obtained.

In the present exemplary embodiment, the voice recognition unit 114 detects a “predetermined operation state” from voice (words) uttered by the user on the basis of voice detected by the microphone 115. For example, character strings indicative of a “predetermined operation state” such as “problem”, “trouble”, and “which?” are stored in advance in the memory 105. It is assumed that the voice recognition unit 114 detects a “predetermined operation state” in a case where a character string indicative of voice detected by the microphone 115 matches a character string indicative of the “predetermined operation state”.

In the present exemplary embodiment, the display 107 and the controller 110 that performs a “screen display process” that will be described later is an example of a “display”, and the controller 110 that performs a “detection process” that will be described later is an example of a “detection unit”. In a case where a user's action is detected, the action recognition unit 112 and the camera 113 are also parts of the “detection unit”. In a case where user's voice is detected, the voice recognition unit 114 and the microphone 115 are also parts of the “detection unit”.

### Home Screen

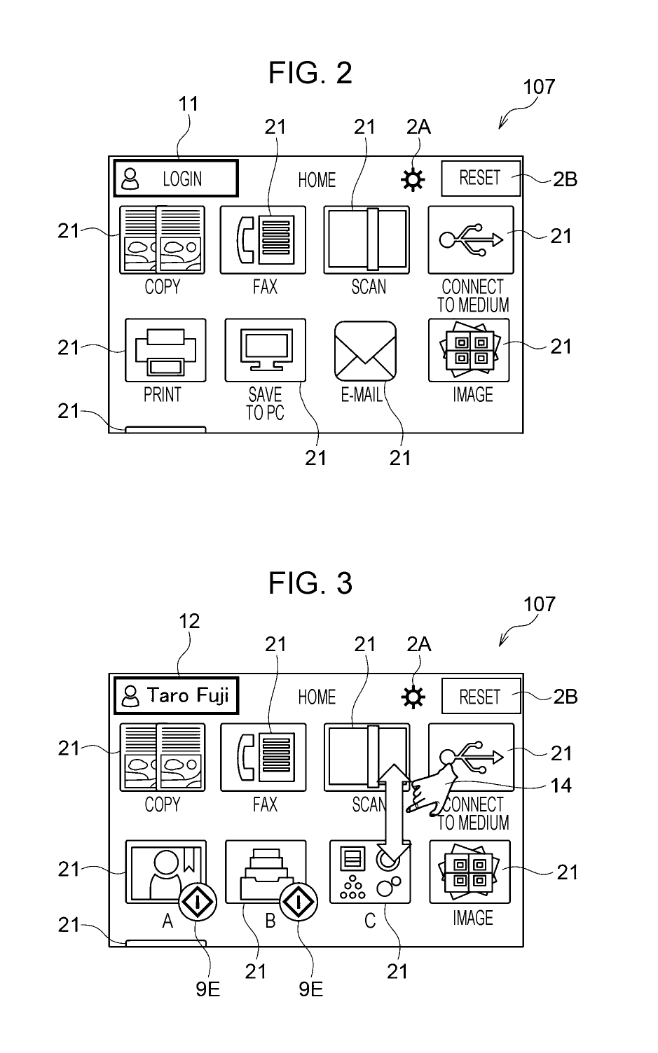

FIGS. 2 through 4 are schematic views illustrating an example of a home screen displayed on the display 107. Before login, the home screen illustrated in FIG. 2 is displayed on the display 107. A login button 11, a setting button 2A, and a reset button 2B are displayed on the home screen before login together with plural selection buttons 21.

The selection buttons 21 are an example of “operators” for selection of service processes. The “operators” are designs (images) representing operation targets on an operation screen. In the present exemplary embodiment, a service process is represented by a design (image). For example, in a case of an operation using a mouse, a service process is selected by an operation of placing a cursor on an operator and clicking. When any of the plural selection buttons 21 is selected (pressed by a user), a function (service process) associated with the selection button 21 is performed.

In the example illustrated in FIG. 2, selection buttons 21 for selection of service processes “copy”, “fax”, “scan”, “connect to medium”, “print”, “save to PC”, “e-mail”, and “image” are displayed as the selection buttons 21. In the example illustrated in FIG. 2, designs used for the selection buttons 21 represent contents of the service processes corresponding to the selection buttons 21.

When the login button 11 is selected by a user, login authentication is executed. In the login authentication, authentication is executed by determining whether or not a user ID, a password, and the like received by the user match information registered in advance.

After the login, a home screen for user illustrated in FIG. 3 is displayed on the display 107. The home screen for user is displayed corresponding to an individual user. The home screen for user is generated on the basis of home screen information stored in association with a user ID.

The stored home screen information includes information on the selection buttons 21 displayed on the home screen for user, information concerning images representing the displayed selection buttons 21, information concerning functions (service processes) associated with the displayed selection buttons 21, and the like.

The plural selection buttons 21, the setting button 2A, and the reset button 2B are also displayed on the home screen for user. After the login, a user name 12 is displayed instead of the login button 11. In the example illustrated in FIG. 3, the selection buttons 21 each for selection of any of service processes “copy”, “fax”, “scan”, “connect to medium”, “A”, “B”, “C”, and “image” are displayed.

In the present exemplary embodiment, new selection buttons 21 created by the user are displayed on the home screen for user in addition to the default selection buttons 21 prepared in advance. That is, in a case where a new service process is registered by a user, a new selection button 21 for selection of the registered service process is added to the home screen. For example, in the example illustrated in FIG. 3, “A”, “B”, and “C” are service processes registered by the user. In the example illustrated in FIG. 3, designs selected by the user are used for the selection buttons 21 for the service processes registered by the user. The designs selected by the user do not necessarily represent contents of the service processes corresponding to the selection buttons 21.

Service processes registered by a user are classified into a “shared” service process that is used by plural users and an “individual” service process that is used by a user who registers the service process. Furthermore, service processes registered by a user are classified into a “general” service process and a “one-touch” service process. Hereinafter, a selection button 21 for selection of a one-touch service process is referred to as a “one-touch selection button 21”.

In the case of a general service process, a confirmation screen for seeking confirmation as to whether or not to execute the service process or a setting screen for detailed setting of a function are displayed when the selection button 21 is selected on the home screen. Execution of the service process is not started just by selecting the selection button 21. Meanwhile, in a case of a one-touch service process, execution of the service process is started just by selecting the one-touch selection button 21 once on the home screen. A confirmation screen and a setting screen are not displayed, and an execution screen indicating that the service process is being executed is displayed.

As illustrated in FIG. 3, a rhombic mark (one-touch badge 9E) indicative of “one-touch” is added to the one-touch selection button 21. In the example illustrated in FIG. 3, the one-touch badge 9E is added to the selection buttons 21 for selection of the service processes “A” and “B”. Registration of a one-touch service process will be described later.

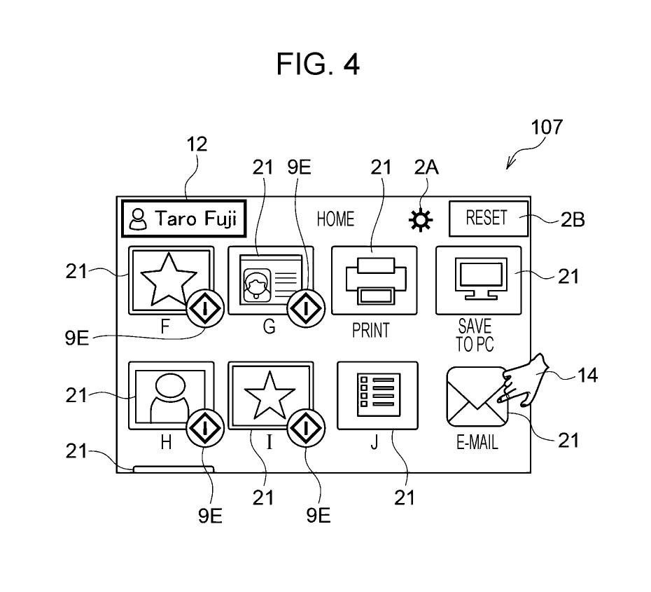

In the present exemplary embodiment, the home screen is constituted by plural pages. FIG. 3 illustrates an initial page. As illustrated in FIG. 3, the initial page is switched to another page illustrated in FIG. 4 when the home screen is scrolled in a direction indicated by the arrow by a user's finger 14. When the reset button 2B at an upper right of the screen is pressed by the user, the default initial page is displayed again.

As a result of switching to another page, other selection buttons 21 appear. In the example illustrated in FIG. 4, selection buttons 21 for selection of service processes “F”, “G”, “print”, “save to PC”, “H”, “I”, “J”, and “e-mail” are displayed. “F”, “G”, “H”, “I”, and “J” are service processes registered by the user. The home screen before the login is also constituted by plural pages, and a page is switched by a user's scrolling operation as in the case of the home screen for user.

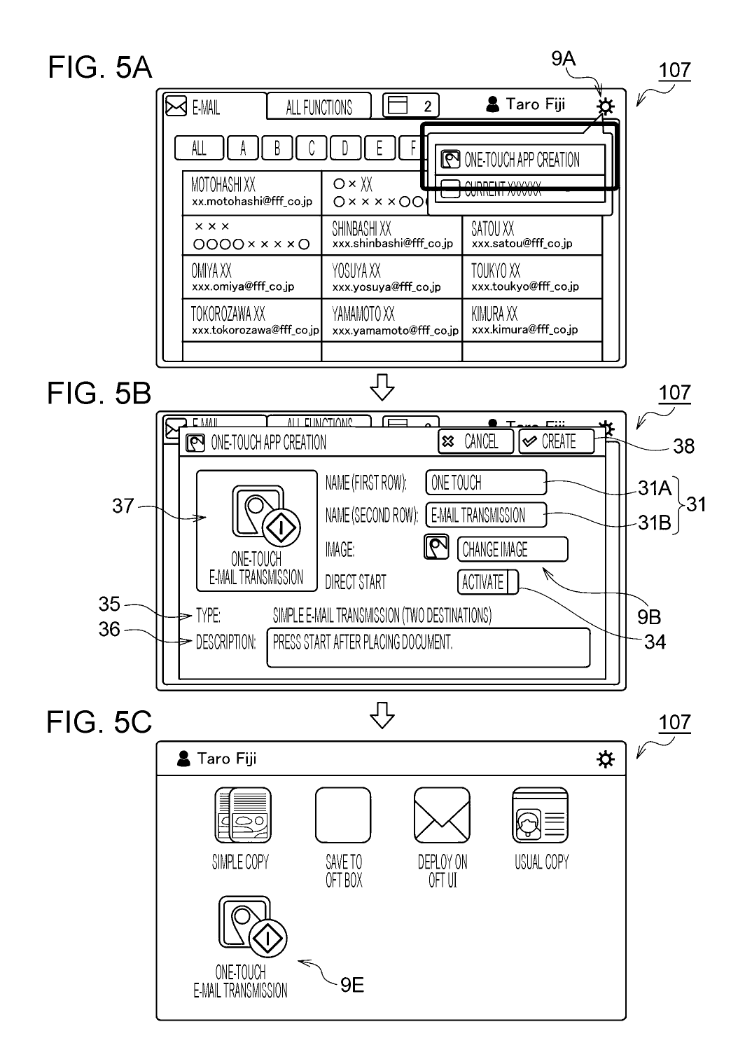

In the case of a general service process, a setting screen for detailed setting is displayed when a selection button 21 is continuously pressed for a predetermined period, and thus detailed setting of a function associated with this selection button 21 becomes possible (see FIG. 5A). Then, a process such as copying starts when the user presses a predetermined button such as a start button. In the present exemplary embodiment, the start button is disposed not on the display screen but on another place (not illustrated) of the image forming apparatus.

In a case where setting of a function of a one-touch service process is changed, the setting of the function is changed after shifting to a home screen for setting (not illustrated). In the present exemplary embodiment, the home screen for setting (not illustrated) is displayed when the user presses the setting button 2A. On the home screen for setting (not illustrated), execution of the one-touch service process is not started even when the one-touch selection button 21 is selected, unlike the home screen illustrated in FIGS. 3 and 4.

On the home screen for setting, a setting screen for detailed setting is displayed when a selection button 21 is continuously pressed for a predetermined period, and thus detailed setting of a function associated with this selection button 21 becomes possible (see FIG. 5A). Then, a process such as copying starts when the user presses a predetermined button such as a start button.

In the present exemplary embodiment, each of the selection buttons 21 on the home screen is moved by a user's operation. Specifically, the selection button 21 is moved by moving the finger 14 while pressing the selection button 21 with the finger 14, i.e., by a drag-and-drop operation.

### One Touch

Next, registration of a one-touch service process is described. FIGS. 5A through 5C illustrate a display screen displayed in a case where a user creates a one-touch selection button. A setting screen illustrated in FIG. 5A is a setting screen for e-mail transmission. For example, when the selection button 21 for “e-mail” is selected on the home screen illustrated in FIG. 4, a setting screen for e-mail transmission is displayed. Note that “e-mail” is a general service process.

When a setting button 9A is pressed by a user on the setting screen illustrated in FIG. 5A, a button for “one-touch app creation” illustrated within the bold black frame is displayed. When this button is selected, a creation screen illustrated in FIG. 5B is displayed. On the creation screen, buttons, boxes, and the like for user's entry of information necessary for creation of a one-touch selection button 21 are displayed. Specifically, name boxes (the first row and the second row) 31, an image changing button 9B, a one-touch selection button 34, a type display part 35, a description box 36, a preview display part 37, a creation button 38, and the like are displayed on the creation screen.

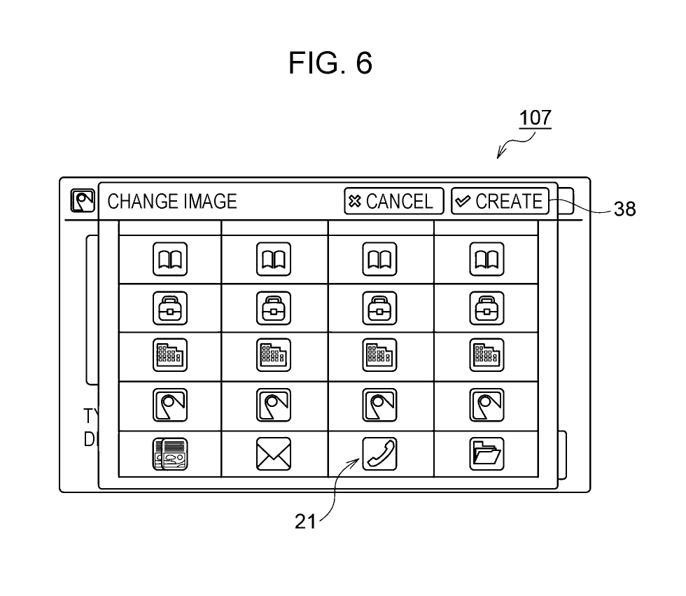

In the name boxes 31, the user enters a name of the selection button 21 to be created. The image changing button 9B is a button for changing an image used for the selection button 21 (operator) to be created. When the image changing button 9B is pressed by the user, a list screen showing a list of images used for a one-touch selection button 21 illustrated in FIG. 6 is displayed. When an image is selected by the user, a default image is changed to the selected image.

The one-touch selection button 34 is a button for selecting whether to “activate” or “deactivate” direct start. The one-touch selection button 34 is a slide-type button that can select whether to “activate” or “deactivate” direct start (one-touch) based on leftward or rightward movement of a tab. In a case where “activate” is selected by the one-touch selection button 34, the created selection button 21 becomes a “one-touch selection button 21”.

In this case, the one-touch badge 9E is added to the one-touch selection button 21 displayed on the home screen as described above. The one-touch badge 9E makes it possible to visually distinguish a one-touch selection button 21 and a general selection button 21 on the home screen. Meanwhile, in a case where “deactivate” is selected by the one-touch selection button 34, the created selection button 21 becomes not a “one-touch selection button 21” but a general selection button 21.

In the type display part 35, a type of a function associated with the selection button 21 to be created is displayed. In the description box 36, a description about the selection button 21 to be created is entered by the user. In the preview display part 37, how the selection button 21 to be created is displayed on the home screen is displayed. The creation button 38 is a button for completing creation of the selection button 21.

When user's entry on the creation screen illustrated in FIG. 5B is finished and the creation button 58 is pressed by the user, the creation screen illustrated in FIG. 5B is switched to the home screen illustrated in FIG. 5C. A one-touch selection button 21 “one-touch e-mail transmission” is added to the new home screen. The one-touch badge 9E is added to the selection button 21 “one-touch e-mail transmission”. Although registration of a one-touch service process has been described above, a general service process can also be registered in the present exemplary embodiment.

Since the new selection button 21 is added by the user as described above, the selection button 21 other than the selection buttons 21 prepared in advance is displayed on the home screen for user. Plural selection buttons 21 given identical or similar designs or names are sometimes displayed. In a case where a one-touch selection button 21 is added, execution of a service process is started just by selecting the one-touch selection button 21 once on the home screen. This makes the user cautious about selecting a selection button 21 and makes the user hesitate. Furthermore, even in a case where the selection buttons 21 are managed by the user, a selection button 21 for a “shared” service process is sometimes added by a third party. For these reasons, it is harder for the user to select a target selection button 21 than in a case where no new selection button 21 is added.

In the present embodiment, a user's operation state before selection of a selection button 21 is monitored, and the home screen for user is changed upon detection of a predetermined operation state so that it becomes easier to select a selection button 21 than on the home screen displayed when the predetermined operation state is detected.

The “predetermined operation state” is a predetermined operation state among states of user's operations performed before selection of a selection button 21 on the home screen. The predetermined operation state includes not only a state in which some sort of operation has been performed, but also a state in which no operation has not been performed within a predetermined period. Examples of the user's operation include not only operations on the display 107 such as selection of a button and scrolling, but also operations based on an action such as gesture input and operations based on voice such as voice input.

### Screen Display Process

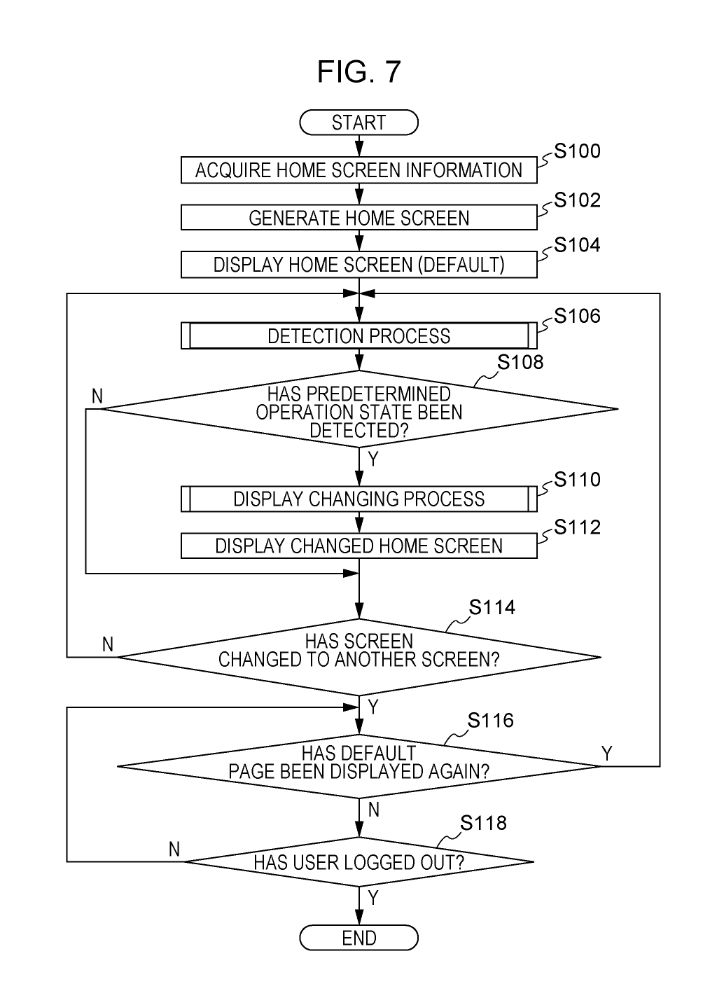

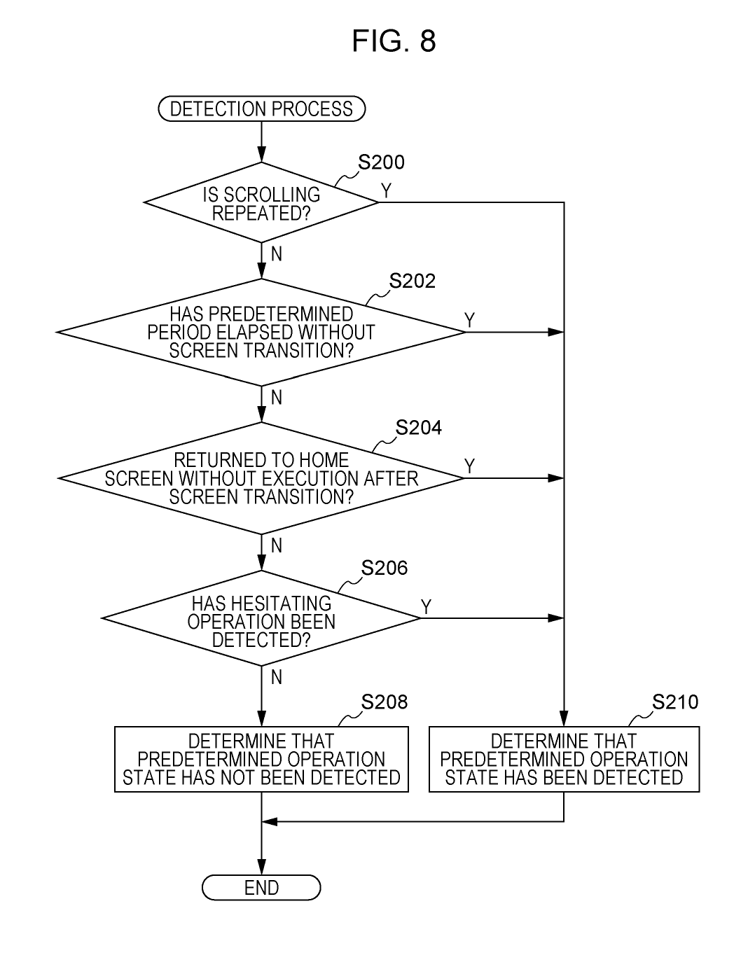

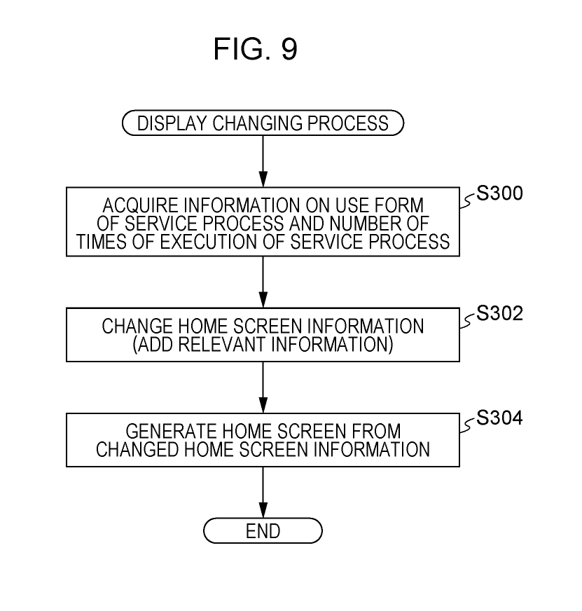

Next, a “screen display process” is described. FIG. 7 is a flowchart illustrating an example of a flow of the “screen display process”. FIG. 8 is a flowchart illustrating an example of a flow of a “detection process”. FIG. 9 is a flowchart illustrating an example of a flow of a “display changing process”. A control program for executing the “screen display process” and the like is stored in advance in the ROM 103 of the controller 100, and the control program is read out from the ROM 103 and executed by the CPU 102. Execution of the “screen display process” is started by user's login.

First, in Step 100, user's home screen information stored in the memory 105 is acquired. Next, in Step 102, a home screen for user is generated on the basis of the acquired home screen information. Next, in Step 104, the generated home screen for user is displayed on the display 107.

Next, in Step 106, a “detection process” for detecting a user's predetermined operation state is performed. In the first exemplary embodiment, a user's predetermined operation state is detected on the basis of a history of user's operations received by the display 107 and a user's image taken by the camera 113. In the first exemplary embodiment, the predetermined operation state is an operation state in which the user is hesitating as to which of the selection buttons 21 should be selected.

In the “detection process”, in Step 200, it is determined whether or not scrolling is repeated on the home screen, as illustrated in FIG. 8. In a case where scrolling is not repeated, Step 202 is performed. In a case where scrolling is repeated, Step 210 is performed in which it is determined that a predetermined operation state has been detected.

Next, in Step 202, it is determined whether or not a predetermined period has elapsed without screen transition. Measurement of a period using a timer (not illustrated) of the controller 100 starts when an initial page of the home screen is displayed and ends when screen transition occurs. In a case where the predetermined period has not elapsed, Step 204 is performed. In a case where the predetermined period has elapsed, Step 210 is performed in which it is determined that a predetermined operation state has been detected.

Next, in Step 204, it is determined whether or not the home screen has been displayed again without execution of a service process after the screen transition. In a case where the home screen has not been displayed again, Step 206 is performed. In a case where the home screen has been displayed again, Step 210 is performed in which it is determined that a predetermined operation state has been detected.

Next, in Step 206, it is determined whether or not the action recognition unit 112 has detected a “hesitating action” on the basis of an image of the user taken by the camera 113. The “hesitating action” is an action such as an action of looking at the home screen without performing any operation for a certain period or an action of moving eyes restlessly in a state where the home screen is displayed.

In a case where no hesitating action has been detected, Step 208 is performed in which it is determined that a predetermined operation state has not been detected, and then the routine is finished. In a case where a hesitating action has been detected, Step 210 is performed in which it is determined that a predetermined operation state has been detected, and then the routine is finished.

In the present embodiment, the predetermined operation state is a state in which scrolling is repeated on the home screen, a state in which a predetermined period has elapsed without screen transition, a state in which the home screen has been displayed again without execution of a service process after screen transition, or a state in which a “hesitating action” is being performed. These states are operation states in which the user is hesitating as to which of the selection buttons 21 should be selected.

In a case where any of the predetermined operation states is detected, the home screen for user is changed so that it becomes easier to operate the home screen. Note that one or more of the states exemplified above may be used as the predetermined operation state. For example, in a case where no camera is provided or in a case where no action recognition unit is provided, the state in which a “hesitating action” is being performed may be omitted.

See the flowchart illustrated in FIG. 7 again. When the “detection step” is finished, it is determined in Step 108 whether or not a predetermined operation state has been detected. In a case where a predetermined operation state has been detected, Step 110 is performed. Meanwhile, in a case where a predetermined operation state has not been detected, Step 114 is performed.

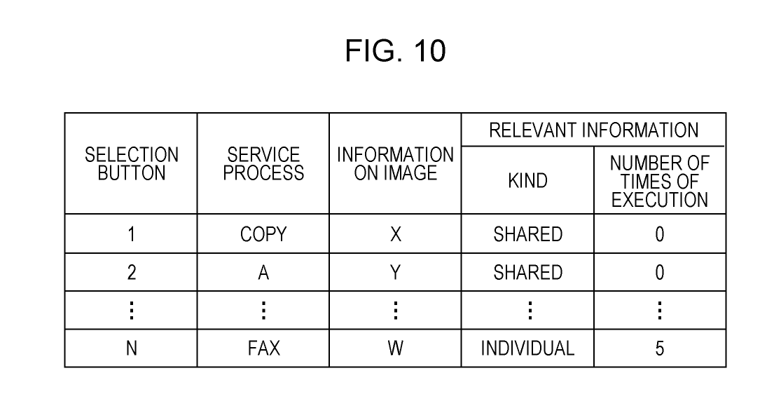

Next, in Step 110, the “display changing process” for changing contents displayed on the home screen is performed. As described above, home screen information is stored for each user. The home screen information includes information on the plural selection buttons 21 displayed on the home screen for user. Associated with each of the plural selection buttons 21 are a kind of function, information on an image representing the selection button 21, and information on the function, as illustrated in FIG. 10. The information on the function is referred to as “relevant information”.

The kind of function is a kind of service process such as copying or fax. The information on an image representing the selection button 21 is information on an image of the selection button 21 displayed on the home screen. The “information on an image representing the selection button 21” displayed on the home screen includes information on an image used for the selection button 21, information on an image added to the selection button 21, and information on an name written along the selection button 21, as in the case of the preview display part 37 illustrated in FIG. 5B. The image added to the selection button 21 is an image of a badge such as the one-touch badge 9E.

The relevant information includes information on a use form of a service process, information on the number of times of execution of the service process, and information on contents of setting of the service process. In the present exemplary embodiment, “shared” or “individual” is stored as the use form of a service process. The information on the number of times of execution of the service process is updated every time the service process is performed. The contents of setting of the service process are detailed contents of setting of a function associated with the selection button 21.

In the present embodiment, in a case where a predetermined operation state has been detected, the “relevant information” is displayed on the selection buttons 21. This makes it easier to select a target selection button 21, thereby reducing the number of times of erroneous selection. As described above, the one-touch badge 9E is added in advance to a one-touch selection button 21.

In the “display changing process”, in Step 300, information indicative of a use form of each service process and the number of times of execution of the service process is acquired, as illustrated in FIG. 9. Next, in Step 302, home screen information is changed on the basis of the acquired information. Specifically, image information of a share badge 9F and a number badge 9G that will be described later is generated, and the “information on images of the selection buttons 21” displayed on the home screen is changed so that the share badge 9F and the number badge 9G overlap the selection buttons 21. Next, in Step 304, a new home screen is generated on the basis of the changed home screen information, and then the routine is finished.

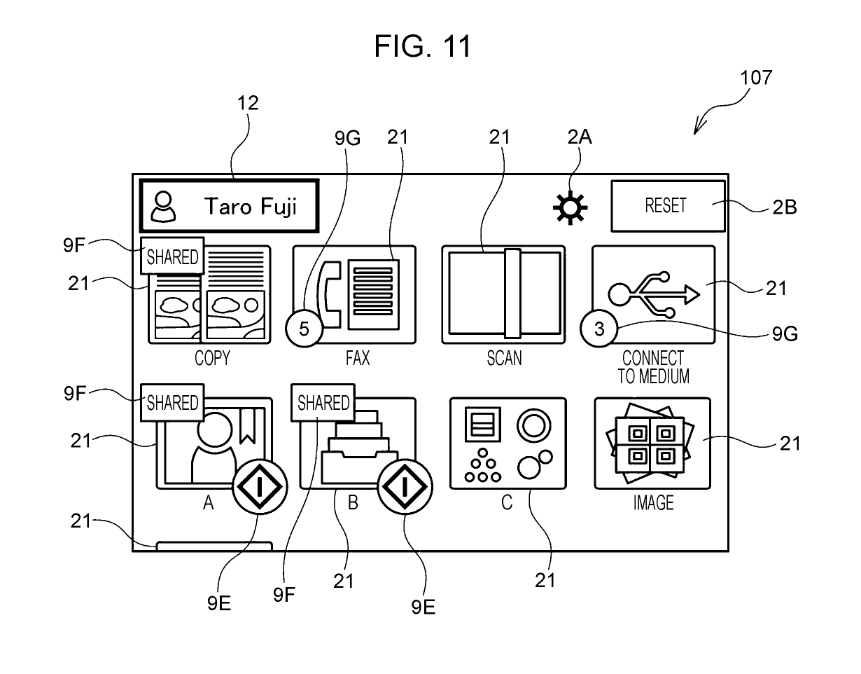

See the flowchart illustrated in FIG. 7 again. When the “display changing process” is finished, the changed home screen is displayed in Step 112. FIG. 11 is a schematic view illustrating an example of the changed home screen. In the first exemplary embodiment, the share badge 9F indicative of a “shared” service process is added to selection buttons 21 for “shared” service processes among the selection buttons 21 displayed on the home screen, as illustrated in FIG. 11.

Furthermore, the number badge 9G indicative of the number of times of execution is added to selection buttons 21 for service processes that have been executed before by the user among the selection buttons 21 displayed on the home screen. Since a new selection button 21 is added by the user, it is harder for the user to select a target selection button 21 than in a case where no new selection button 21 is added, as described above. The user who selects a selection button 21 displayed on the home screen selects the target selection button 21 while using the added share badge 9F and number badge 9G as clues.

Next, in Step 114, it is determined whether or not screen transition has occurred. When a selection button 21 is selected, the home screen is changed to a confirmation screen or a setting screen. In a case where screen transition has occurred, Step 116 is performed. Meanwhile, in a case where no screen transition has occurred, Step 106 is performed again. The “detection process” and the subsequent processes are repeated until screen transition occurs.

Next, in Step 116, it is determined whether or not an initial (default) page of the home screen has been displayed again. In a case where the default page has been displayed again, Step 106 is performed again. The “detection process” and the subsequent processes are repeated every time the default page is displayed. Meanwhile, in a case where the default page is not displayed again, Step 118 is performed. Next, in Step 118, it is determined whether or not the user has logged out. In a case where the user has logged out, the routine is finished. Meanwhile, in a case where the user has not logged out, Step 116 is performed again.

### Second Exemplary Embodiment

In the second exemplary embodiment, a user's predetermined operation state is detected on the basis of a history of user's operations received by a display 107 and comparison between selection buttons 21 displayed on the home screen. In the second exemplary embodiment, the predetermined operation state is an operation state in which it is estimated that the user is hesitating as to which of the selection buttons 21 should be selected. The second exemplary embodiment is similar to the first exemplary embodiment except for a “detection process” and a “display changing process”, and description of parts identical to those in the first exemplary embodiment is omitted.

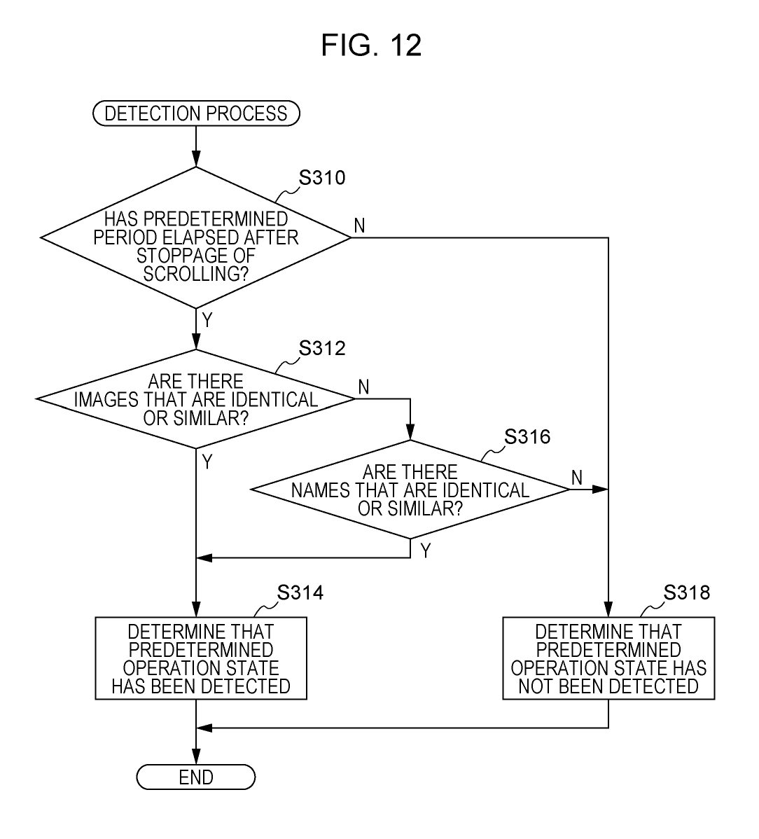

FIG. 12 is a flowchart illustrating an example of a flow of a “detection process” according to the second exemplary embodiment. In the “detection process” according to the second exemplary embodiment, it is determined in Step 310 whether or not a predetermined period has elapsed after stoppage of scrolling on the home screen. In the present embodiment, it is determined that the predetermined period has elapsed in a case where a period from last scrolling is equal to or longer than the predetermined period.

In a case where the predetermined period has elapsed, Step 312 is performed. Meanwhile, in a case where the predetermined period has not elapsed, Step 318 is performed in which it is determined that a predetermined operation state has not been detected, and then the routine is finished.

Next, in Step 312, it is determined whether or not plural selection buttons 21 displayed on the home screen for user include plural selection buttons 21 that are given identical or similar images. As for comparison between images used for selection buttons 21, for example, images that have an identical design and an identical color may be regarded as being “identical” and images that have an identical design and different colors may be regarded as being “similar”.

In the present embodiment, an image used for a selection button 21 is given a numerical value (e.g., a serial number) in advance in accordance with attributes of the image such as a design and a color. For example, images having an identical design are given successive serial numbers on a list screen showing a list of images used for a one-touch selection button 21 illustrated in FIG. 6. In a case where images used for compared two selection buttons 21 are given an identical numerical value, these images are regarded as being “identical”. Meanwhile, in a case where a “difference” between values given to used images is within a predetermined range (e.g., not less than 1 and not more than 5), the images are regarded as being “similar”.

In a case where plural selection buttons 21 that are given identical or similar images are included, Step 314 is performed in which it is determined that a predetermined operation state has been detected, and then the routine is finished. In a case where plural selection buttons 21 that are given identical or similar images are not included, Step 316 is performed.

Next, in Step 316, it is determined whether or not the plural selection buttons 21 displayed on the home screen for user include plural selection buttons 21 that are given identical or similar names on the basis of the home screen information. Along with the selection buttons 21, names of service processes such as “copy”, “fax”, and “one-touch e-mail” are written. As for comparison between names, for example, names that perfectly match each other are regarded as being “identical”, and names that partially match each other are regarded as being “similar”.

In a case where plural selection buttons 21 that are given identical or similar names are included, Step 314 is performed in which it is determined that an predetermined operation state has been detected, and then the routine is finished. In a case where plural selection buttons 21 that are given identical or similar names are not included, Step 318 is performed in which it is determined that a predetermined operation state has not been detected, and then the routine is finished.

In the present embodiment, the predetermined operation state is a state in which a user has stopped scrolling on a home screen (page) having at least one of (i) plural selection buttons 21 that are given identical or similar images and (ii) plural selection buttons 21 that are given identical or similar names. These states are operation states in which it is estimated that the user is hesitating as to which of the selection buttons 21 should be selected. By displaying the “relevant information” on the selection buttons 21 upon detection of a predetermined operation state, it becomes easier to select a target selection button 21, and as a result, the number of times of erroneous selection is reduced.

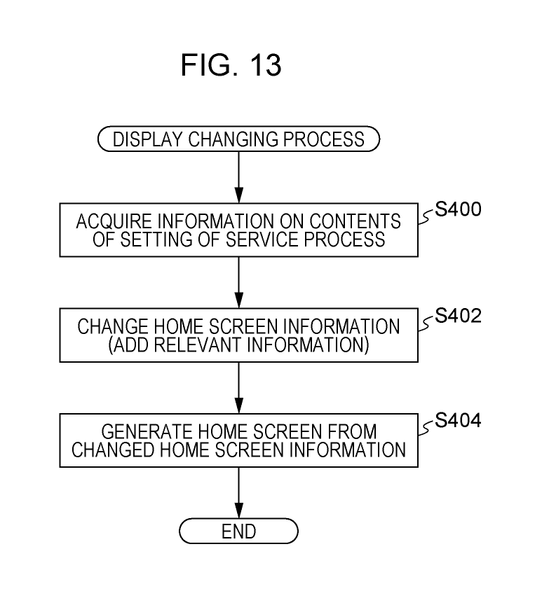

FIG. 13 is a flowchart illustrating an example of a flow of a “display changing process” according to the second exemplary embodiment. In the “display changing process” according to the second exemplary embodiment, in Step 400, information indicative of contents of setting of service processes is acquired. Next, in Step 402, the home screen information is changed on the basis of the acquired information. Specifically, image information of a setting contents display part 9H that will be described later is generated, and image information on designs of the selection buttons 21 is changed so that the setting contents display part 9H overlaps the selection buttons 21. Next, in Step 404, a new home screen is generated on the basis of the changed home screen information, and then the routine is finished.

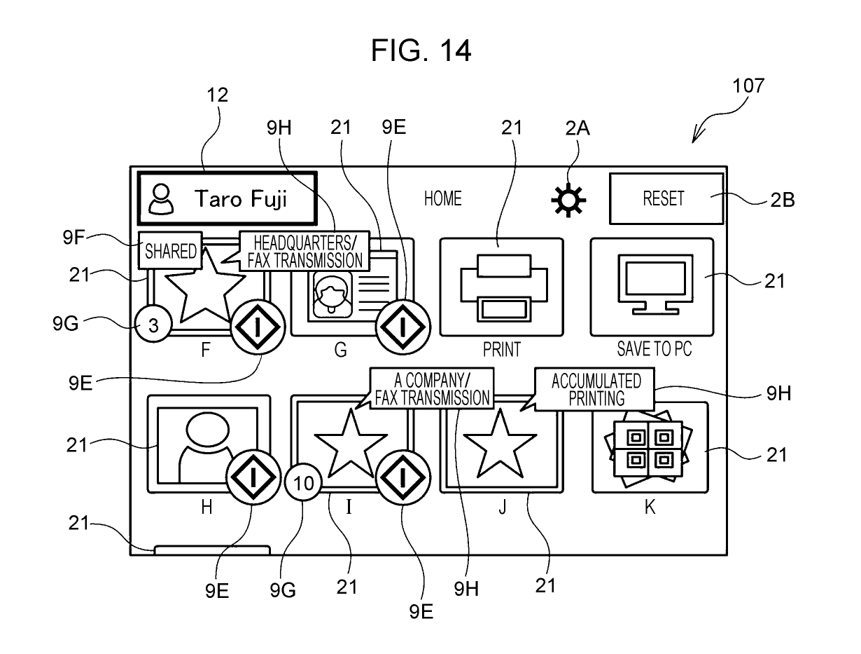

When the “display changing process” is finished, the changed home screen is displayed. FIG. 14 is a schematic view illustrating an example of the changed home screen. In the second exemplary embodiment, each of plural selection buttons 21 that are given identical or similar images or names among the selection buttons 21 displayed on the home screen is given the setting contents display part 9H associated with the selection button 21, as illustrated in FIG. 14.

On the home screen having plural selection buttons 21 that are given identical or similar images or names, it is hard for the user to select a target selection button 21. In the present embodiment, each of plural selection buttons 21 that are given identical or similar images or names is given the setting contents display part 9H associated with the selection button 21. Since the selection buttons 21 are distinguished by the setting contents display parts 9H, the user selects any of the selection buttons 21 while referring to the setting contents display parts 9H.

In the example illustrated in FIG. 14, all of selection buttons 21 for selection of service processes of “F”, “I”, and “J” use an image of a star although colors of the images are unknown. These plural selection buttons 21 that are given identical or similar images are given different pieces of relevant information. The selection button 21 for “F” is given a setting contents display part 9H “headquarters/FAX transmission”, the selection button 21 for “I” is given a setting contents display part 9H “A company/FAX transmission”, and the selection button 21 for “J” is given a setting contents display part 9H “accumulated printing”. As illustrated in FIG. 14, a share badge 9F or a number badge 9G may be added to the selection buttons 21.

Whether or not plural selection buttons 21 that are given identical or similar images or names are included may be determined for all pages of the home screen constituted by plural pages or may be determined for a page displayed when scrolling is stopped. Furthermore, whether or not plural selection buttons 21 that are given identical or similar images or names are included may be determined in a restricted range. For example, selection buttons 21 added as “shared” service processes by a third party may be subjected to the process for determining whether or not plural selection buttons 21 that are given identical or similar images or names are included.

### Reference Example

In the reference example, a user's predetermined operation state is detected from a result of detection of a document detection sensor of the image forming apparatus 10, an image of a user taken by the camera 113, presence or absence of document data accumulated in the memory 105, and contents of an image forming instruction. In the reference example, the predetermined operation state is a user's operation state in which the user is trying to select any of the selection buttons 21. The reference example is similar to the first exemplary embodiment other than the procedures of the “detection process” and the “display changing process”, and therefore description of parts identical to those in the first exemplary embodiment is omitted.

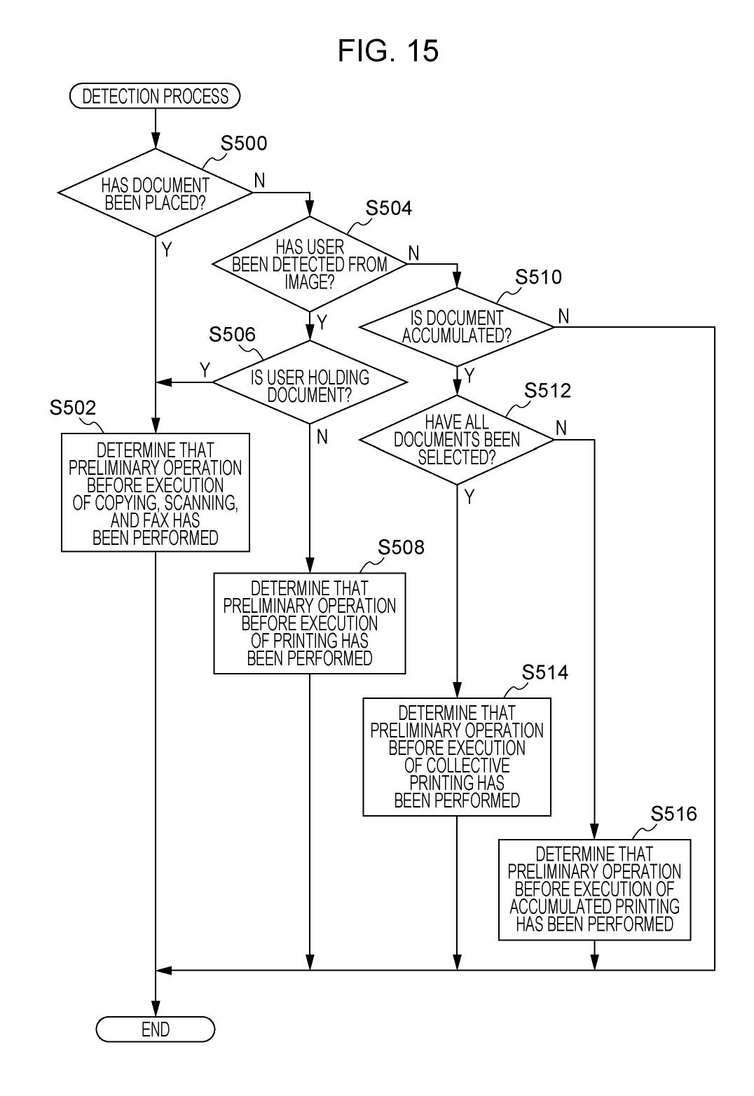

FIG. 15 is a flowchart illustrating a flow of a “detection process” according to the reference example. In the “detection process” according to the reference example, it is determined in Step 500 whether or not a document has been placed on a document feeder. A document detection sensor provided in the document feeder of the image reading unit 108 detects the placed document. Based on a result of this detection, it is determined whether or not a document has been placed on the document feeder. In a case where a document is placed, Step 502 is performed.

In Step 502, it is determined that a preliminary operation before execution of any of service processes of copying, scanning, and fax has been performed, and the routine is finished. That is, it is determined that a user is trying to select a selection button 21 for any of the service processes of copying, scanning, and fax.

In a case where no document is placed in Step 500, Step 504 is performed. In Step 504, it is determined whether or not a user has been detected on the basis of an image taken by the camera 113. When the user approaches the image forming apparatus 10 and enters a photographing range of the camera 113, the user is detected. In a case where the user is detected, Step 506 is performed.

In Step 506, it is determined whether or not the user is holding a document on the basis of the image of the user taken by the camera 113. In a case where an “action of approaching while holding a document” is detected from the image of the user by the action recognition unit 112, it is determined that the user is holding a document. Meanwhile, in a case where the “action of approaching while holding a document” is not detected from the image of the user by the action recognition unit 112, it is determined that the user is not holding a document.

In a case where the user is holding a document, Step 502 is performed. In Step 502, it is determined that a preliminary operation before execution of any of the service processes of copying, scanning, and fax has been performed.

In a case where the user is not holding a document, Step 508 is performed. In Step 508, it is determined that a preliminary operation before execution of a service process of printing has been performed, and the routine is finished. That is, it is determined that the user is trying to select a selection button 21 for the service process of printing.

In a case where no user is detected in Step 504, Step 510 is performed. In Step 510, it is determined whether or not document data is accumulated in the memory 105 by a user. In a case where document data is accumulated, Step 512 is performed. In a case where no document data is accumulated, the routine is finished. In a case where document data is accumulated, the service process of printing is performed on the basis of contents of an image forming instruction. In Step 512, it is determined whether or not all of the accumulated document data is selected on the basis of contents of the image forming instruction from the user.

In a case where all of the accumulated document data is selected, Step 514 is performed. In Step 514, it is determined that a preliminary operation before execution of a service process “collective printing” for collectively printing accumulated documents that have not been output yet has been performed, and the routine is finished. That is, it is determined that the user is trying to select a selection button 21 for the service process of collective printing.

In a case where not all of the accumulated document data is selected, i.e., in a case where part of the accumulated document data is selected, Step 516 is performed. In Step 516, it is determined that a preliminary operation before execution of a service process “accumulated printing” for printing the selected accumulated documents has been performed, and the routine is finished. That is, it is determined that the user is trying to select a selection button 21 for the service process of accumulated printing.

In a case of “accumulated printing”, a data list of accumulated documents is displayed before execution of the service process. Meanwhile, in the case of “collective printing”, the service process is executed without displaying a data list of accumulated documents.

In the reference example, the predetermined operation state is an operation state in which a document has been placed on the document feeder, an operation state in which a user has approached an image forming apparatus while holding a document, an operation state in which a user has approached an image forming apparatus without holding a document, an operation state in which a user has given an image forming instruction while selecting all of accumulated document data, or an operation state in which a user has given an image forming instruction while selecting part of accumulated document data. These operation states are operation states in which a user's next operation, i.e., which of the selection buttons 21 the user is trying to select can be predicted.

By displaying a selection button 21 for selection of a predicted service process in a more noticeable manner than the other selection buttons 21 upon detection of the predetermined operation state, it becomes easier to select a target selection button 21. This leads to a reduction in the number of times of erroneous selection.

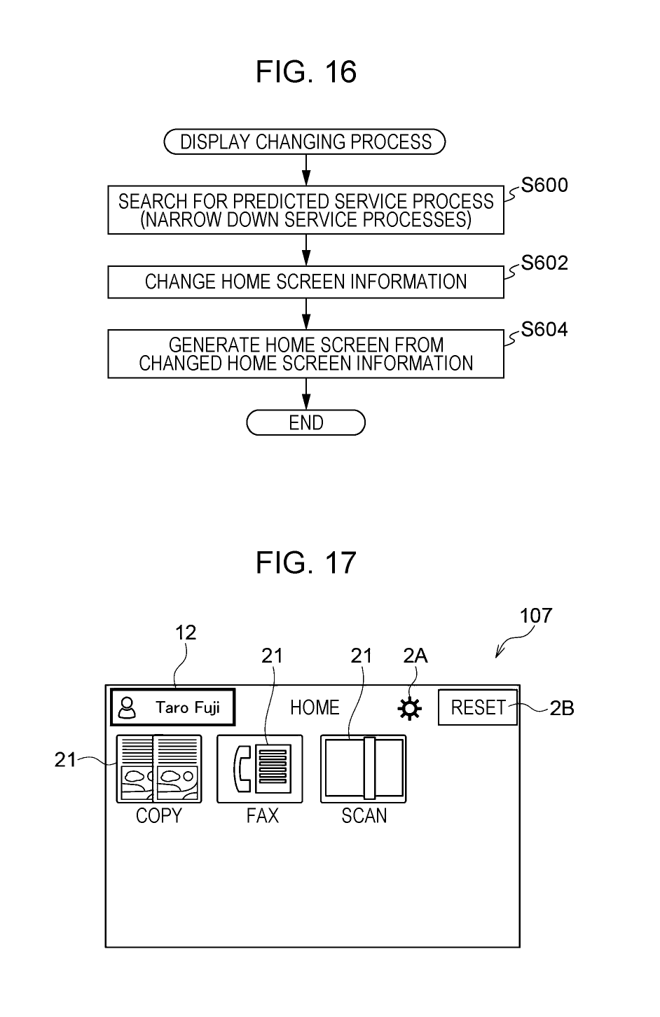

FIG. 16 is a flowchart illustrating a flow of a “display changing process” according to the reference example. In the “display changing process” according to the third exemplary embodiment, a predicted service process is searched for from home screen information on the basis of a result of determination (a service process predicted from a preliminary operation) in Step 600. For example, in a case where the predicted service process is “printing”, a service process registered as printing is searched for.

Next, in Step 602, home screen information is changed on the basis of a result of the search. Specifically, the home screen information is changed so that a selection button 21 for selection of the predicted service process is displayed and the other selection buttons 21 are deleted. That is, information on the other selection buttons 21 is deleted from information on plural selection buttons 21 displayed on a home screen for user. Next, in Step 604, a new home screen is generated on the basis of the changed home screen information, and then the routine is finished.

FIG. 17 is a schematic view illustrating an example of a changed home screen. When the “display changing process” is finished, a changed home screen is displayed (Step 112 of FIG. 7). The example illustrated in FIG. 17 is a home screen displayed in a case where it is determined that a preliminary operation before execution of any of the service processes of copying, scanning, and fax has been performed. Only selection buttons 21 for copying, scanning, and fax that are predicted service processes are displayed on the home screen.

In the reference example, a service process to be selected by a user is predicted, and only a selection button 21 for the predicted service process is displayed on a home screen. This reduces the number of selection buttons 21 (options) displayed on the home screen, thereby allowing the user to select a target selection button 21 without trouble.

Although an example in which selection buttons 21 other than a selection button 21 for a predicted service process are deleted has been described in the reference example, it is only necessary that the selection button 21 for the predicted service process be displayed in a more noticeable way than the other selection buttons 21. For example, the selection button 21 for the predicted service process may be displayed in a larger size than the other selection buttons 21 or may be displayed at a higher density than the other selection buttons 21. Alternatively, the other selection buttons 21 may be displayed in a smaller size than the selection button 21 for the predicted service process or may be displayed at a lower density than the selection button 21 for the predicted service process. Furthermore, information associated with the selection button 21 for the predicted service process may be added as a badge to the selection button 21, as in the first and second exemplary embodiments.

An information processing apparatus according to the reference example includes a display on which plural operators for selection of service processes are displayed and a detection unit that detects a user's operation state before selection of any of the operators, wherein in a case where a predetermined operation state is detected as a preliminary operation for execution of a service process, the display selectively displays one or more operators for selection of a service process predicted from the preliminary operation among the plural operators.

The display may selectively display the one or more operators in a more noticeable manner than the other operators. For example, the display displays, on each of the one or more operators, relevant information associated with the operator. Alternatively, the display selectively displays the other operators in a less noticeable manner than the one or more operators. For example, the displays hides the other operators.

### Modification

Note that the configurations of the information processing apparatus and program described in the above exemplary embodiments are examples, and it is needless to say that the configurations can be changed without departing from the spirit of the present invention.

For example, although a display process in the image forming apparatus 10 has been described in the above exemplary embodiments, this display process can be performed in a similar manner in apparatuses other than the image forming apparatus 10. For example, the display process can be performed in an information processing apparatus having a display that receives a touch operation such as a tablet terminal.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display that displays a plurality of operators for selection of service processes; and
a detection unit that detects an operation state of a user before selection of any of the operators,
wherein in a case where a predetermined operation state is detected, the display displays, on each of at least one or more of the plurality of operators displayed on the display, relevant information associated with the operator.

2. The information processing apparatus according to claim 1, wherein
the predetermined operation state is a state in which page turning is repeated, a state in which a predetermined period has elapsed without screen transition, or a state where an original screen has been displayed again without execution of a service process after screen transition.

3. The information processing apparatus according to claim 1, wherein
the predetermined operation state is a state in which page turning has been stopped on a page including a plurality of operators that are identical or similar to each other.

4. The information processing apparatus according to claim 3, wherein
the plurality of operators that are identical or similar to each other are at least one of (i) a plurality of operators that are given identical or similar images and (ii) a plurality of operators that are given identical or similar names.

5. The information processing apparatus according to claim 4, wherein
attributes of the images are expressed by numerical values;
in a case where it is determined as a result of comparison that two numerical values given to images are identical to each other, the images are regarded as being identical; and
in a case where determined as a result of comparison that a difference between two numerical values given to images is within a predetermined range, the images are regarded as being similar.

6. The information processing apparatus according to claim 3, wherein
the at least one or more of the operators are the plurality of operators that are identical or similar to each other; and
different pieces of relevant information are displayed on the plurality of operators that are identical or similar to each other, respectively.

7. The information processing apparatus according to claim 6, wherein
the plurality of operators that are identical or similar to each other are included in a page displayed to the user.

8. The information processing apparatus according to claim 1, wherein
the plurality of operators include an operator other than an operator that is prepared in advance.

9. The information processing apparatus according to claim 1, wherein
the plurality of operators include an operator that is set so that execution of a service process is started by selection of the operator.

10. The information processing apparatus according to claim 1, wherein
the relevant information is at least one of information indicative of a use form of a service process, information indicative of the number of times of execution of a service process, and information indicative of contents of setting of a service process.

11. The information processing apparatus according to claim 1, wherein
the operation state of the user includes an operation state produced by voice or an action; and
the predetermined operation state is detected by voice recognition or action recognition.

12. A non-transitory computer readable medium storing a program causing a computer to execute a process comprising:
displaying a plurality of operators for selection of service processes on a display; and
displaying, on each of at least one or more of the plurality of operators displayed on the display, relevant information associated with the operator in a case where a predetermined operation state is detected.

13. An information processing apparatus comprising:
display means for displaying a plurality of operators for selection of service processes; and
detection means for detecting an operation state of a user before selection of any of the operators,
wherein in a case where a predetermined operation state is detected, the display means displays, on each of at least one or more of the plurality of operators displayed on the display means, relevant information associated with the operator.
